(19) United States
(12) Patent Application Publication
(10) Pub. No.: US 2006/0098173 A1
(43) Pub. Date: May 11, 2006

(54) Reflector and liquid crystal display module with the reflector

(75) Inventors: Kenichirou Naka, Kanagawa (JP); Michiaki Sakamoto, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KAWASAKI (JP)

(21) Appl. No.: 11/266,322

(22) Filed: Nov. 4, 2005

(30) Foreign Application Priority Data
Nov. 9, 2004 (JP) 2004-324493

(51) Int. Cl. G03B 21/28

(52) U.S. Cl. 353/98

(57) ABSTRACT

A reflector capable of preventing stain caused from the interference among the beams of light, for reflecting light incident on an LCD module to utilize the light as a light source for display. The reflector includes a plurality of projecting and recessing patterns which are irregularly disposed on the reflector, and each projecting and recessing pattern is disposed corresponding to prescribed polygon shape as a grid, and is repeated in the plane direction of the reflector so that the length of the edge or the distribution of distance between the centers of each projecting and recessing pattern conforms to the Gaussian distribution. The reflector also includes a unit area constituted of the plurality of polygon shapes, so that one edge of the unit area is integral multiple of a unit pixel and substantially 1900 μm or more, and smaller than or equal to the entire screen of the LCD module.

### BACKGROUND OF THE INVENTION

1. Field of the Invention

The present invention relates to a liquid crystal display (LCD) module, particularly to a reflector formed on a reflective-type or semi-transmission type LCD module.

2. Description of the Related Art

Since liquid crystal display (LCD) modules have features such as small in size, small thickness and low power consumption, they have been put into practical use in various fields such as office automation equipment, portable equipment. Different from CRT or EL display, an LCD has no function to emit light for oneself. Therefore, the LCD called as transmission-type is provided with a backlight source and is adapted so as to control the display by switching the transmission/shut-off of the backlight using a liquid crystal panel. The transmission-type LCD module can provide bright screen with its backlight being independent of ambient conditions. However, the transmission-type LCD module has the following disadvantage. That is, since the backlight source consumes a large electric power, particularly when the transmission-type LCD module is driven with a battery, the operation time is short.

In order to solve the above disadvantage of power consumption of the backlight source, there has been proposed a reflective-type LCD module, which displays by utilizing ambient light. In the reflective-type LCD module, in place of the backlight source, a reflector is provided to reflect ambient light therewith, and by switching the transmission/shut-off of the reflected light using a liquid crystal panel, the display is controlled. Owing to this, the power consumption, size and weight can be reduced. However, on the other hand, there arises the following disadvantage; i.e., when the ambient is dark, sufficient reflection of ambient light used as the light source for display is hardly taken in resulting in a poor visibility.

Therefore, in order to solve the respective disadvantages; i.e., the increase of power consumption due to the backlight source in the transmission type and the poor visibility due to the ambient conditions in the reflective-type, there has been proposed an LCD module, in which each pixel is provided with a transmission area and a reflection area. Such LCD module, which is provided with both of the functions of a transmission-type LCD module and a reflective-type LCD module, is called as semi-transmission type LCD module.

In the above reflective-type LCD module and semi-transmission type LCD module, ordinarily, on a substrate formed with a switching element such as thin film transistor (TFT) (TFT substrate), a resin layer having projecting and recessing is formed, and on the resin layer, a reflection film such as metal film is provided to form a reflector. The reflector diffusely reflects ambient light. However, in the case where the projecting and recessing of the resin layer is regularly disposed, the following disadvantage arises. That is, particularly when beams of light, which has directivity such as direct sunlight, enters, the beams of light reflected by each projecting and recessing, interfere with each other causing interference fringes or a stain called as Newton ring.

The stain will be described with reference to figures. FIG. 12A and FIG. 12B are diagrams schematically showing the state where beams of light are reflected at each projecting and recessing portion in a reflector. FIG. 12A shows an example where the projecting and recessing are formed regularly. Since the distance between the projecting and recessing is equal to each other and the inclination of the projecting and recessing is also oriented to the identical direction, beams of light entering from a specific direction are reflected toward a specific direction at each projecting and recessing causing interference among the reflected beams of light. On the other hand, FIG. 12B shows an example where the projecting and recessing are formed irregularly. Since the projecting and recessing are disposed irregularly, the distance between the projecting and recessing is different from each other, and the inclination of the projecting and recessing is also oriented to various directions. Even when beams of light having the directivity enter, the incident beams of light can be reflected to various directions. Owing to this, the interference among the beams of light can be prevented.

As LCD modules provided with reflectors, in which the projecting and recessing are formed at irregular positions and in irregular configurations as described above, the following LCD modules are disclosed in the prior art documents.

Japanese Patent Application Laid-Open No. Hei 11-337935 (pp. 2-3, FIG. 1) discloses the following reflective-type LCD module. That is, projecting-recessing electrodes for scattering the reflection in a unit pixel are structured of plural areas each of which has different standard deviation of distribution of the distance between the neighboring recessing portions or projecting portions. Japanese Patent Application Laid-Open No. 2001-201743 (pp. 2-3, FIG. 1) discloses a reflective-type LCD module in which projecting-recessing electrodes for scattering reflection in a unit pixel are structured of plural areas including areas where the projecting portions or the recessing portions are disposed regularly and areas where the projecting portions or the recessing portions are disposed irregularly and the plural areas are disposed in a row-column configuration. And Japanese Patent Application Laid-Open No. 2003-302633 (pp. 5-16, FIG. 2) and Japanese Patent Application Laid-Open No. 2003-302742 (pp. 5-16, FIG. 2) disclose a mask, in which transparent areas or opaque areas are disposed irregularly in the plane direction in an area of 100 to 2000 dots or in the entire screen as a unit.

As described above, disposing the projecting and recessing irregularly in the reflector can prevent the interference prevented and the stain can be reduced. However, the degree of the interference also varies depending on the degree of the irregularity. Therefore, in the case where the degree of the irregularity is low, the interference cannot be prevented satisfactorily. As a result, there resides a disadvantage such that the stain cannot be satisfactorily reduced.

With respect to the above disadvantage, although the above Japanese Patent Application Laid-Open No. Hei 11-337935 and Japanese Patent Application Laid-Open No. 2001-201743 describe the following arrangement in which the distribution of the distance among the recessing portions or projecting portions are structured in four areas each having a standard deviation different from each other. However, the documents do not describe what degree the standard deviation should be different from each other. Further, the above Japanese Patent Application Laid-Open No. 2003-302633 and Japanese Patent Application Laid-Open No. 2003-302742 describe that the transparent areas or opaque areas are disposed irregularly in the plane direction. However, the documents do not describe the degree of the irregularity. Therefore, even when the arts disclosed in the prior art documents are applied, the stain due to the interference among the beams of light cannot be reliably prevented.

Furthermore, in addition to the regularity of the projecting and recessing within the unit area, the stain occurs depending on the size of the unit area. That is, even when the interference within the unit area can be prevented by disposing the projecting and recessing irregularly, when the unit areas are formed repeatedly in the LCD module, macroscopically, the projecting and recessing have the regularity. Particularly, in the case where the unit area is small, due to the regularity of the unit areas themselves, the projecting and recessing among the unit areas have the regularity. As a result, the interference of light occurs resulting in a stain.

With respect to the above disadvantages, the Japanese Patent Application Laid-Open No. 2003-302633 and Japanese Patent Application Laid-Open No. 2003-302742 describe that an area of 100 to 2000 dots or the entire screen constitutes the unit area. However, since the dimensions of a pixel constituting the LCD module depends on the LCD module, even when the number of dots is prescribed, the actual dimensions of the unit area cannot be prescribed. Further, in the case where the dimensions of the unit area is smaller than a prescribed value, how irregularly the projecting and recessing are disposed within the unit area, the projecting and recessing generate the regularity among the unit areas. Therefore, the interference among the beams of light cannot be satisfactorily prevented. Therefore, the stain cannot be prevented.

### SUMMARY OF THE INVENTION

The present invention has been proposed in view of the above-described disadvantages. The primary object of the present invention is to provide a reflector, which is capable of preventing stain caused from the interference among the beams of light due to the regularity of the projecting and recessing, and an LCD module of reflective-type or semi-transmission type provided with the reflector.

To achieve the above object, an LCD module of the present invention is a reflector for reflecting light incident on an LCD module to utilize the light as a light source for display, wherein the reflector is formed with projecting and recessing pattern in which recessing portion or projecting portion are irregularly disposed in each polygon, and the dimension of the unit area is prescribed so that one edge of the polygon is integral multiple of the unit pixel and substantially 1900 μm or more and smaller than the size of the entire screen of the LCD module.

The projecting and recessing pattern may be any of the following patterns:
A. A pattern in which a prescribed polygon is repeated in the plane direction so that the length of the edge or the distribution of distance between the centers conforms to the Gaussian distribution, and the center or all of the edges of the polygons are formed in a recessing portions or projecting portions respectively.
B. A pattern in which a polygon, of which center or each of the apexes is disposed at a position where intersection point of regular grids is shifted, is repeated in the plane direction so that the length of the edge or the distance between the centers conforms to the Gaussian distribution, and the center or all of the edges of the polygons of the projecting and recessing pattern are formed in a recessing portions or projecting portions respectively.
C. A pattern in which a prescribed circle or ellipse is repeated in the plane direction so that the distance between the centers conforms to the Gaussian distribution, and the center or the entire periphery of the circle or ellipse is formed with any one of the recessing portion or projecting portion.
D. A pattern in which a circle or ellipse, of which center is disposed at a position where the intersection point of regular grids is shifted, is repeated in the plane direction so that the distance between the centers conforms to the Gaussian distribution, and the center or the entire periphery of the circle or ellipse is formed with any one of the recessing portion or projecting portion.

In the present invention, the standard deviation of the Gaussian distribution is preferably 3 or more and 14 or less, or 5 or more and 14 or less. A reflective-type LCD module or a semi-transmission type LCD module of the present invention is provided with the reflector.

As described above, according to the arrangement of the present invention, the unit area formed with irregular projecting and recessing pattern is prescribed not by the number of dots buy by its dimension, and further, also the irregularity of the projecting and recessing pattern within each unit area is prescribed by the standard deviation of the Gaussian distribution. Accordingly, both of the interference caused from the regularity of the projecting and recessing within the unit area and the interference caused from the regularity of the projecting and recessing among the unit areas can be reliably prevented. Thus, the reflective-type LCD module or the semi-transmission type LCD module with satisfactory display quality with no stain can be achieved.

### BRIEF DESCRIPTION OF THE DRAWINGS

FIG. 1 is a diagram illustrating a unit area of a projecting and recessing pattern formed on a reflector of an LCD module in accordance with an embodiment of the present invention, and irregularity of the projecting and recessing pattern;

FIG. 2 is a diagram showing the relationship between the irregularity of the projecting and recessing pattern and the standard deviation of the Gaussian distribution;

FIG. 3 is a diagram showing the correlation between the standard deviation and the degree of stain;

FIGS. 4A, B and C are diagrams each showing an example of variation of the configuration of basic grid constituting a unit area;

FIG. 5 is a diagram showing the correlation between the dimension of a unit area formed with the projecting and recessing pattern and the existence of interference/repetition;

FIG. 6 is a sectional view schematically showing the arrangement of a reflective-type LCD module in accordance with one embodiment of the present invention;

FIGS. 7A to D are diagrams showing the manufacturing process of the reflective-type LCD module in accordance with one embodiment of the present invention;

FIG. 8 is a sectional view schematically showing the arrangement of a semi-transmission type LCD module in accordance with one embodiment of the present invention;

FIGS. 9A to D are diagrams showing the manufacturing process of the semi-transmission type LCD module in accordance with one embodiment of the present invention;

FIGS. 10A, B and C are diagrams each showing the correlation between the irregularity of the projecting and recessing pattern and the number of diffraction in the reflective-type LCD module.

FIGS. 11A, B and C are diagrams showing the correlation between the irregularity of the projecting and recessing pattern and the number of diffraction in the semi-transmission type LCD module; and

FIGS. 12A and B are diagrams each schematically showing a state of reflection of light in the cases where the projecting and recessing are regularly disposed and irregularly disposed.

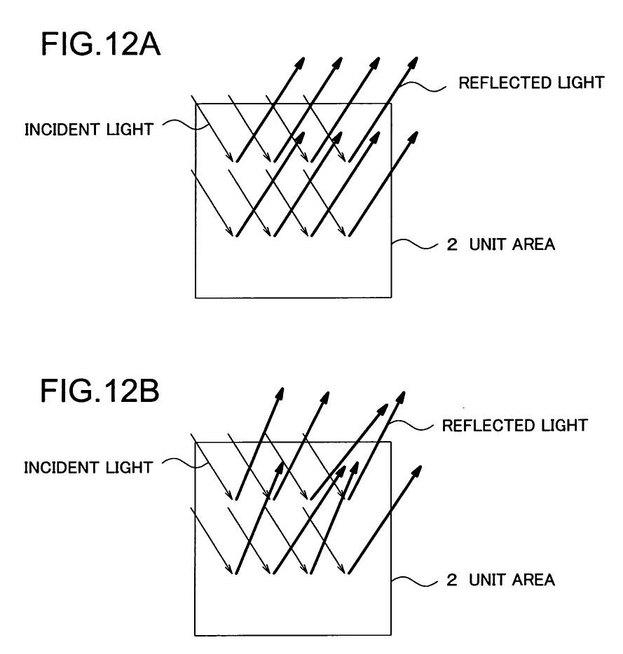

### DESCRIPTION OF THE EXEMPLARY EMBODIMENTS

Best mode for carrying out the present invention will be described below with reference to the drawings.

As described in the related art, in the reflective-type LCD module or semi-transmission type LCD module, a reflector is formed on one substrate, and in the reflector, the projecting and recessing are formed. Thereby ambient light as the light source for display is reflected scatteringly. In the case where the projecting and recessing are disposed regularly, when beams of light, which having the directivity like direct sunlight, enter, interference occur among the reflected beams of light. As a result, there arises such a disadvantage that stain is generated. To reduce the stain, it is important to increase the irregularity of the projecting and recessing pattern of the reflector within the unit area. And further, to eliminate the regularity among the unit areas, it is important to increase the dimensions of the unit area. In order to prescribe the irregularity of the projecting and recessing pattern and the dimensions of the unit area to prevent the stain, the following experiments was carried out.

First of all, to prescribe the irregularity to prevent the stain, while changing the distribution of the distance between apexes of the projecting and recessing pattern with respect to the distance between the basic grids formed on the substrate, the tendency thereof was investigated.

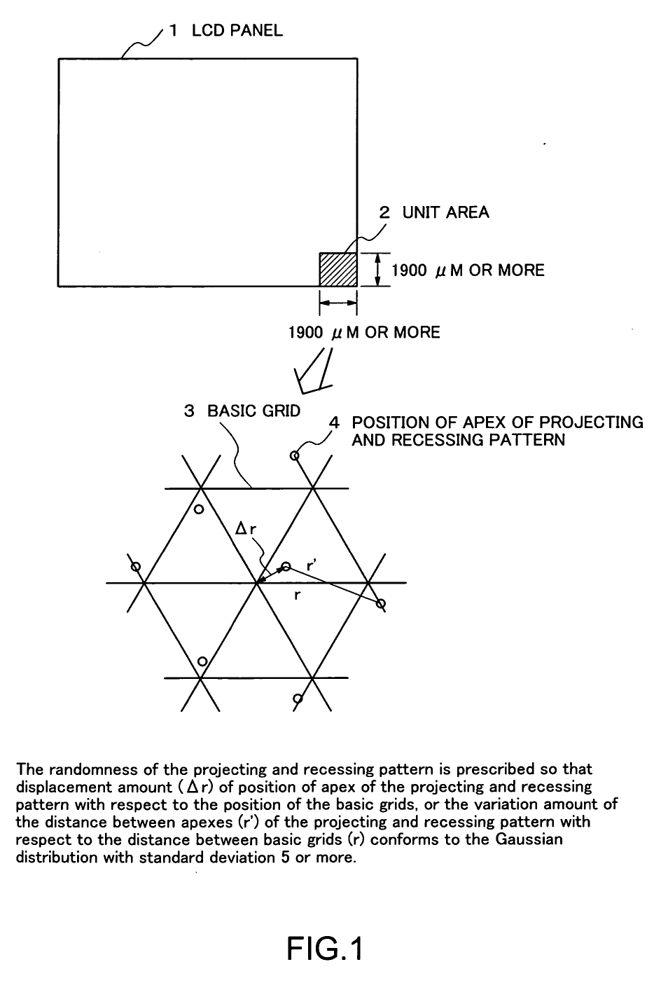

FIG. 1 is a diagram illustrating a unit area of a projecting and recessing pattern, which is formed in the reflector of an LCD module in accordance with one embodiment of the present invention, and the irregularity of the projecting and recessing pattern. As for a unit area 2 in the liquid crystal panel 1 will be described later. In the unit area 2, a basic grid 3 is formed, and in connection with the configuration of the basic grid 3, the position of an apex 4 of the projecting and recessing pattern is formed.

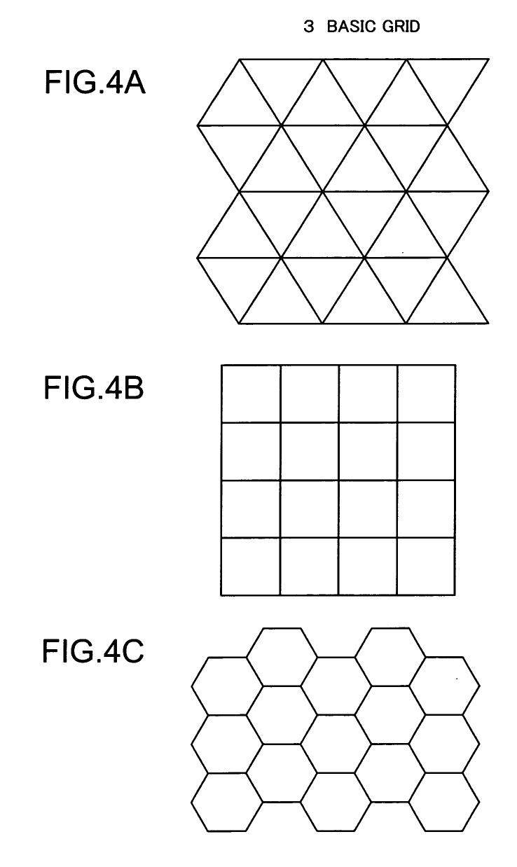

Here, the wording “basic grid” means a configuration, in which a figure of the grid having an arbitrary basic figure such as regular triangle, regular tetragon, rectangle, circle, ellipse or hexagon is employed as the basic figure, and the figure of grid is repeatedly dispose regularly. In FIG. 1, a regular triangle is given as the figure of grid. (FIGS. 4A, B and C are diagrams each showing an example of variation of the configuration of the basic grid constituting the unit area. However, the configuration of the basic grid is not limited to these regular configurations. For example, any polygon having a configuration such as triangle having three different sides, lozenge, pentagon capable of being combined with each other or the like may be employed as the basic figure.) The point, which is the intersection point of the figure of grids (portion corresponding to angle), is defined as apex, and the portions corresponding to the edges of the figure is defined as grid.

Using the position corresponding to the apex of the figure of the grid as the reference, and when the apex of the projecting and recessing pattern is disposed at the position where the position of apex thereof is shifted irregularly, the distribution of the distance between apexes of the projecting and recessing pattern corresponding to the distance between the basic grids was investigated. Here, the distribution tendency of the displacement amount of the position of intersection point of the figure of the grid and the position of apex of the projecting and recessing pattern (Δr in FIG. 1), or the variation amount of the distance between the basic grids (edge length of the figure of grid; indicated with r in FIG. 1) and the distance between apexes of the projecting and recessing patterns (indicated with r′ in FIG. 1) was investigated.

Here, the configuration of the projecting and recessing and the distance between apexes of the projecting and recessing pattern will be described. There are two patterns in the configuration of the projecting and recessing. A first pattern is a projecting and recessing pattern, in which the portion corresponding to the edges of the figure of grid becomes a projecting portion or a recessing portion, while a second pattern is a projecting and recessing pattern, in which a configuration of a circle or ellipse corresponding to the apex of the figure of grid becomes a projecting portion or recessing portion. In the first projecting and recessing pattern, in which the center or all edges of a polygon are formed as the recessing portion or projecting portion, the length of the edge of the figure of grid or the distance between the centers of the figures of grids is defined as the distance between apexes of the projecting and recessing patterns. In the second the projecting and recessing pattern, in which the center or the entire periphery of a circle or ellipse is formed as a recessing portion or projecting portion, the distance between the centers of the circles or ellipses is defined as the distance between apexes of the projecting and recessing patterns.

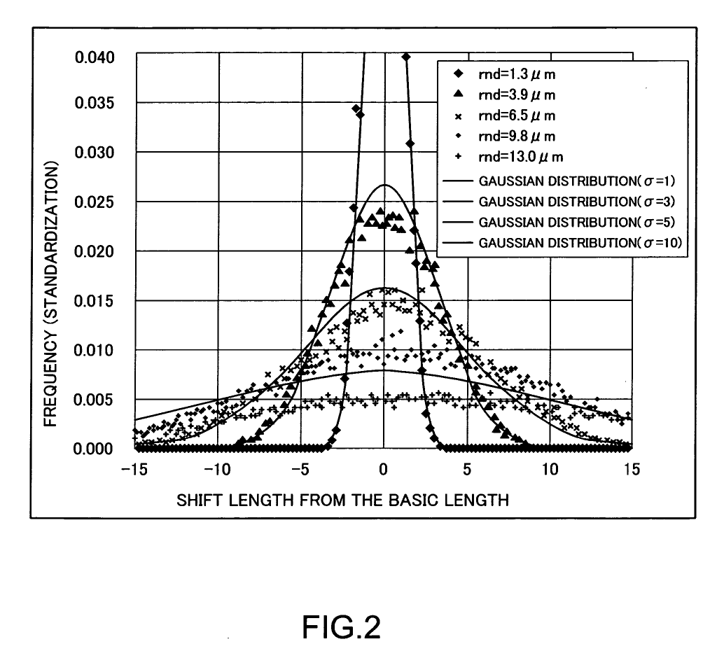

FIG. 2 shows a result of investigation of the distribution of the distance between apexes of the projecting and recessing pattern with respect to the distance between the basic grids formed on the substrate. FIG. 2 shows the relationship between the irregularity of the projecting and recessing pattern and the standard deviation of the Gaussian distribution. In FIG. 2, the abscissa indicates shift length from the basic length (variation amount of the distance between apexes with respect to the distance between grids), and the ordinate indicates standardized value of the frequency. (Here, the wording “standardization” means that, defining the total number of samples to be assessed as 1, the ratio of the number of samples from which the numerical value indicated with the abscissa with respect to the total number of samples to be assessed is defined as “frequency”). In FIG. 2, “rnd” indicates the degree of the irregularity.

When the shift amount is prescribed as irregular by the wording “shift irregularly”, it allows the shift to be made any distance. Therefore, in this experiment, the “maximum value of the shift amount” is prescribed, and the shift was made irregularly within the range. As for the relationship with the Gaussian distribution, when the shift is made irregularly within a prescribed maximum value of the shift amount, a distribution close to the Gaussian distribution is obtained. On the other hand, when the length of the projecting portion or recessing portion is within the range of the prescribed Gaussian distribution, there is a possibility that the pattern has been shifted irregularly within the prescribed maximum value of the shift amount.

As described above, when the intersection point of the basic grids disposed regularly is shifted irregularly, the degree of the irregularity is prescribed with the “maximum value of shift amount”.

Referring to FIG. 2, when the degree of the irregularity is 1.3 μm, 3.9 μm, 6.5 μm and 9.8 μm, respectively, the distribution of the distance between the grids well agrees with the Gaussian distribution when each standard deviation is 1, 3, 5 and 10 respectively. Therefore, it is understood that the degree of irregularity of the projecting and recessing pattern can be prescribed using the standard deviation in the Gaussian distribution.

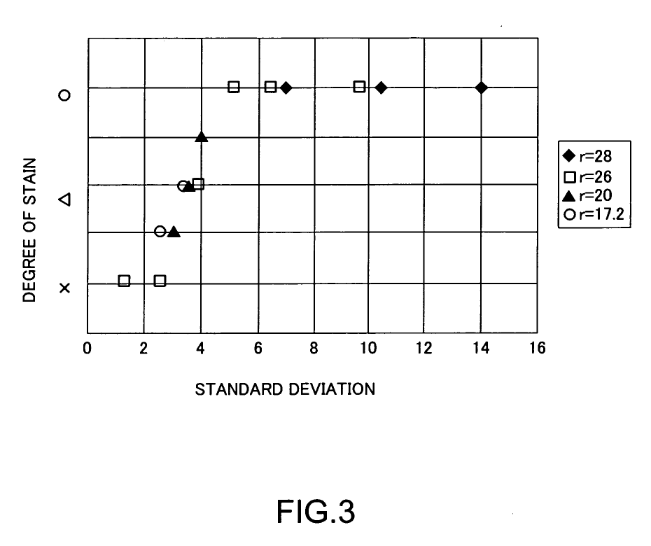

Next, the changes of the stain with respect to the standard deviation of the Gaussian distribution were investigated. FIG. 3 shows the investigation result.

In FIG. 3, the abscissa indicates standard deviation (for example, in the case of the basic grids, in which figures of regular triangle as shown in FIG. 4A are repeatedly disposed, the degree of irregularity of the displacement amount of the position of apex of the projecting and recessing pattern with respect to the point of intersection of figures of grid); and the ordinate indicates the degree of stain due to the interference, which is visibly recognized at a portion other than the regular reflection. In the ordinate, “x” indicates a state in which visible interference of blight lines is generated; “Δ” indicates a state in which, rather fine blight lines are visibly recognized, but displayed images are recognizable; and “O” indicates a state in which, no blight lines are recognized, and displayed images can be easily recognizably. Using the distance between grids (“r” in FIG. 1) as the parameter, each result, which is visibly recognized, is plotted. That is, as described above, when the “degree of irregularity” is changed, the distribution of the distance between the grids agrees with the Gaussian distribution. When the distance between the basic grids is changed as 17.2 μm, 20 μm, 26 μm and 28 μm to change the degree of the irregularity, and based on the degree of irregularity, standard deviation of the Gaussian distribution is computed and plotted on the abscissa in FIG. 3, and the degree of interference at that time is plotted on the ordinate.

Referring to FIG. 3, it is understood that, when the standard deviation is small, since the regularity of the projecting and recessing remains, the stain is generated; when the standard deviation is 3 or more, the stain is reduced; and when standard deviation is 5 or more and 14 or less, the stain is not generated. Also, it is understood that the above tendency does not depend on the distance between grids (“r” in FIG. 1). Therefore, it is understood that the stain can be prevented without depending on the distance between basic grids when the projecting and recessing are disposed within the following conditions of distribution; i.e., “distance between grids after being shifted irregularly from the basic grid” prescribed by the “degree of the irregularity” (which agrees with “standard deviation of the Gaussian distribution”).

Accordingly, when the distance between apexes of the projecting and recessing pattern is prescribed so as to conform to the Gaussian distribution with standard deviation of 3 or more and 14 or less (preferably, 5 or more and 14 or less), the stain can be reliably prevented. The stain can be also reliably prevented when each of the centers or the apexes of the projecting and recessing pattern are disposed at a position where the intersection point of the regular grid is shifted so that the distance between apexes of the projecting and recessing pattern conforms to the Gaussian distribution of which standard deviation is 3 or more and 14 or less (preferably, 5 or more and 14 or less).

Hereinbefore, there has been described a basic grid in which a regular triangle is repeatedly disposed as shown in FIG. 4A. However, the configuration of the basic figure used as the reference of the basic grid is not particularly limited. An arbitrary polygon such as regular tetragon shown in FIG. 4B, a hexagon shown in FIG. 4C, a rectangle or a rhombus may be employed. Also, as for the projecting and recessing pattern, the portion corresponding to the center or edges of the polygon may be formed in a concave shape or convex shape. The center or the entire periphery of a circle or ellipse may be formed with dot pattern in a concave shape or convex shape.

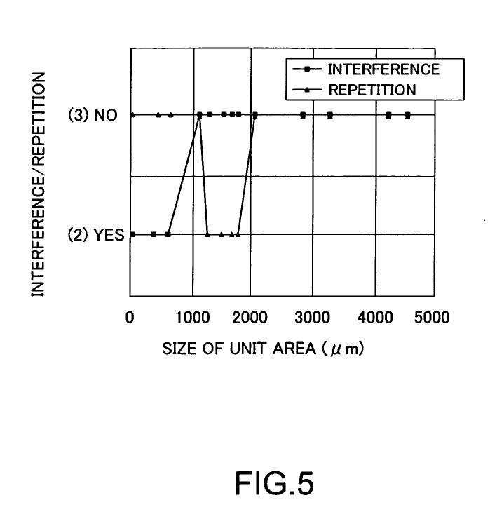

Next, in order to prescribe the size of the unit area in which the stain is not generated, it was investigated how the stain changed when the size of the unit area was changed. FIG. 5 shows the investigation result.

In FIG. 5, the abscissa indicates the dimension of one edge of the unit area, and the ordinate indicates the existence of the interference or repetition (phenomenon in which the distribution of the projecting and recessing within the unit area are visibly recognized).

Referring to FIG. 5, it is understood that, when the unit area is small, the interference occurs; but as the dimension of the unit area gets larger, the interference reduces gradually; when the dimension of the unit area is approximately 700 μm or more, the interference does not occur. And when the size of the unit area reaches a specific degree, sometimes a deviation is found in the distribution of the projecting and recessing within the unit area. In such case, when the unit area is within a specific range, the deviation of the distribution of the projecting and recessing is recognized as a repeated pattern. However, it is understood that, when the unit area is approximately 1900 μm or more, the repetition does not occur. Based on these results, it is understood that, to reduce the stain caused from the size of the unit area, the unit area should be prescribed as below; i.e., the dimensions of the unit area should be integral multiple of the unit pixel; one edge should be 1900 μm or more, and smaller than the entire screen.

Based on the above-described results, as shown in FIG. 1, the dimensions of the unit area 2 should be prescribed as described below. That is, the size of the unit area 2 should be integral multiple of the unit pixel, one edge thereof should be 1900 μm or more, and the size should be smaller than or equal to the size of the entire screen of the liquid crystal panel. In each unit area 2, the projecting and recessing pattern, in which a basic figure such as polygon, circle, ellipse or the like is repeatedly formed, should be prescribed so that the variation of edge length or the distance between the centers conforms to the Gaussian distribution; and the center or each of the apexes should be disposed to a position where the intersection point of regular grids is shifted so that the variation of the length of the edge or the distance between the centers conforms to the Gaussian distribution. Thereby, the regularity of the projecting and recessing of the reflector within the unit area and the interference caused from the projecting and recessing of the reflector among the unit area can be satisfactorily prevented. By forming a reflector, in which the projecting and recessing are formed conforming to the above prescriptions within an LCD module, a reflective-type LCD module or a semi-transmission type LCD module with no stain and superior in quality of display can be achieved.

### EXAMPLES

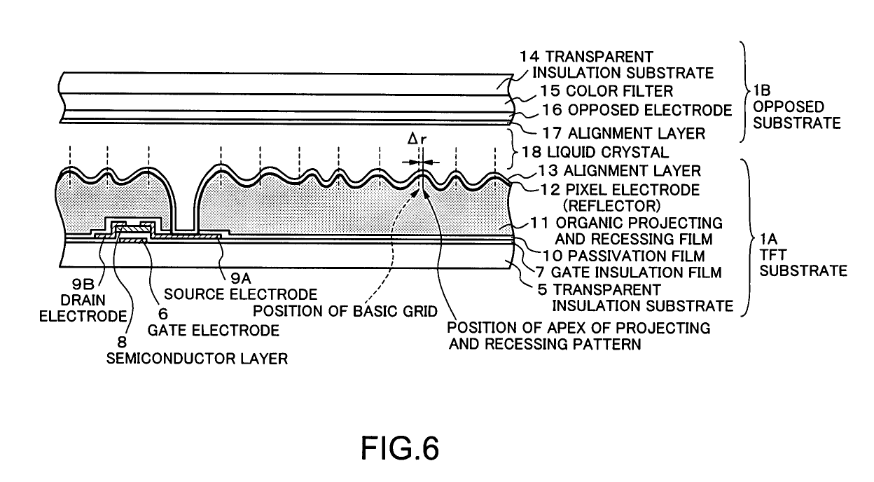

A reflector in accordance with one embodiment of the above-described invention and an LCD module provided with the reflector will be described in detail with reference to FIG. 6 through FIG. 11.

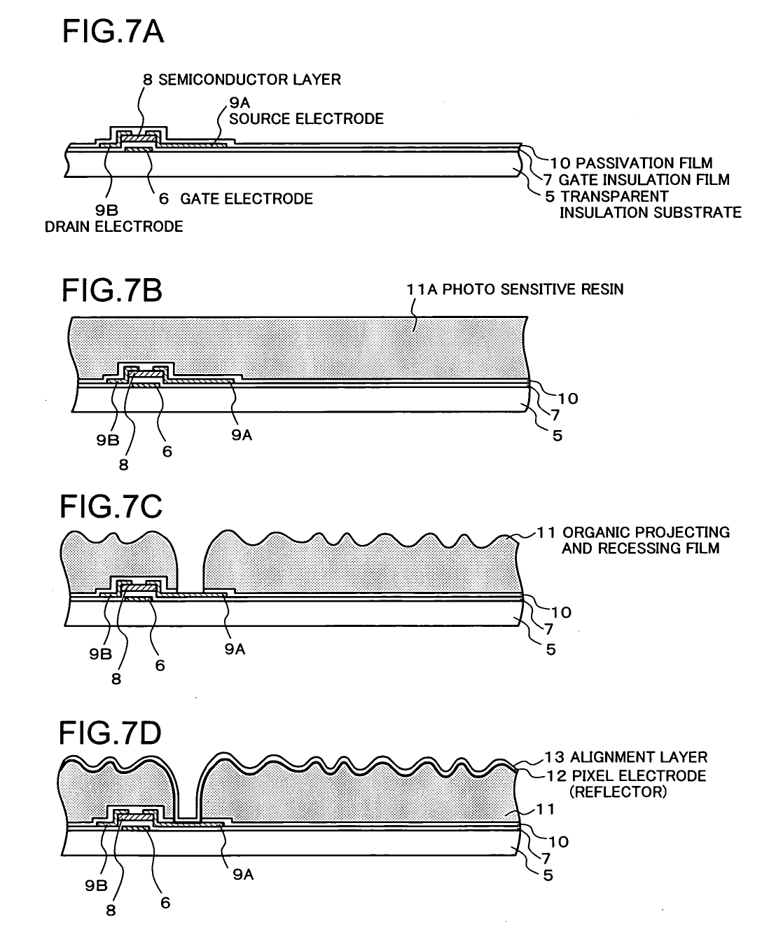

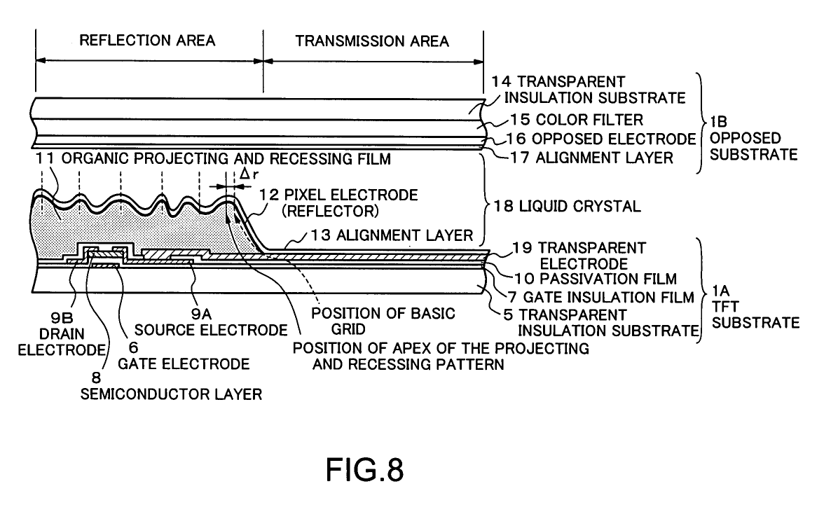

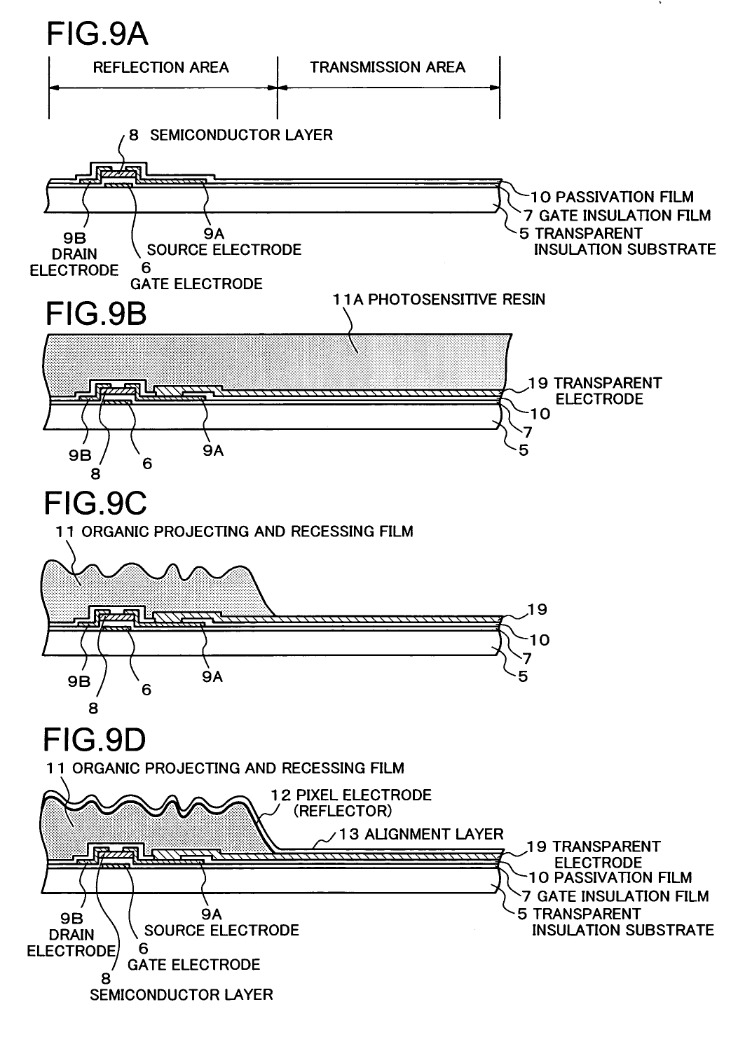

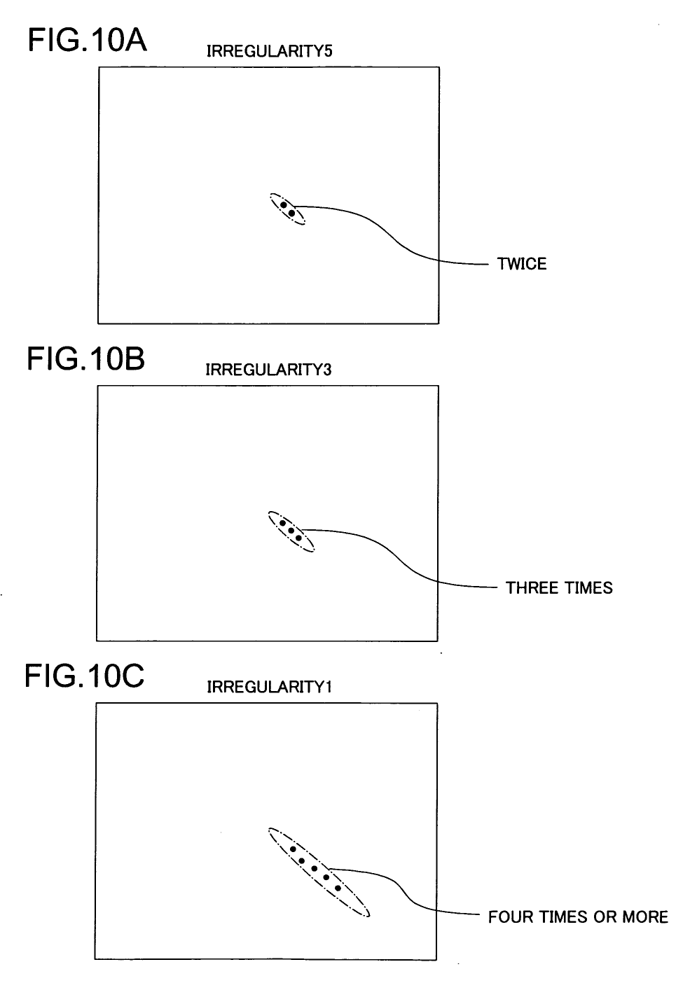

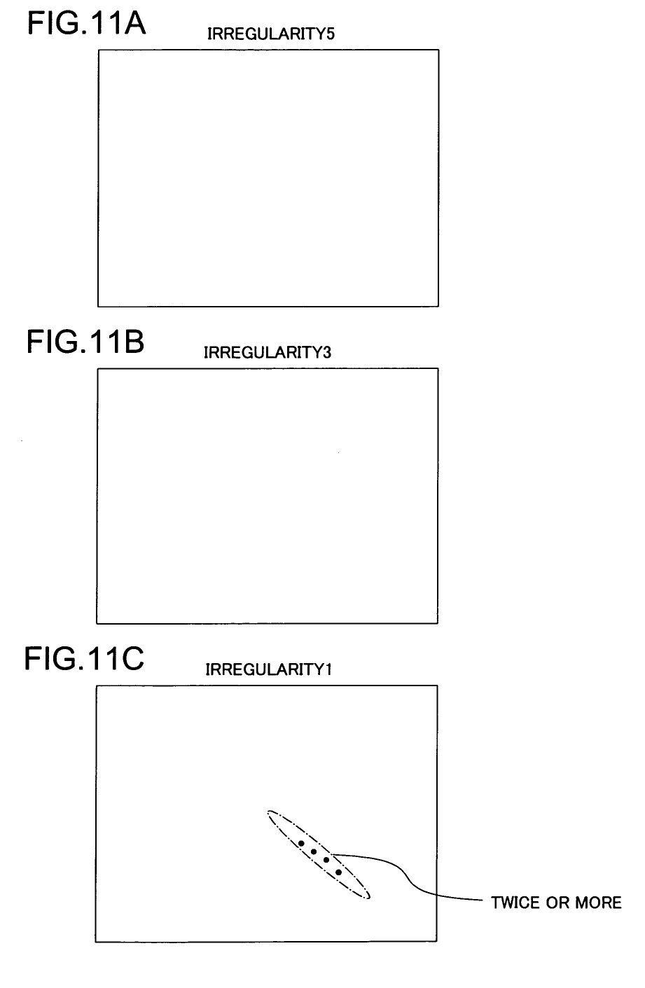

FIG. 6 is a sectional view schematically showing the arrangement of a reflective-type LCD module in accordance with one embodiment of the present invention; and FIGS. 7A, 7B, 7C and 7D are sectional views illustrating the manufacturing process in accordance with the manufacturing method thereof. FIG. 8 is a sectional view schematically showing the arrangement of a semi-transmission type LCD module in accordance with one embodiment of the present invention; and FIGS. 9 A, 9B, 9C and 9D show sectional views illustrating the manufacturing process in accordance with the manufacturing method thereof. FIGS. 10A, 10B and 10C show observation results of an image diffracted on the reflective-type LCD module; and FIGS. 11 A, 11B and 11C show observation result of an image diffracted on a semi-transmission type LCD module.

As shown in FIG. 6, the reflective-type LCD module comprises a substrate formed with switching elements such as TFT (herein, referred to as TFT substrate 1a), an opposed substrate 1b opposing to the TFT substrate 1a and a liquid crystal 18 sandwiched between the TFT substrate 1a and the opposed substrate 1b. In the TFT substrate 1a, formed on a transparent insulation substrate 5 are a gate line and gate electrode 6, a gate insulation film 7, a semiconductor layer 8, data line and source/drain electrodes 9a and 9b; and formed on a passivation film 10 covering the above is an organic projecting and recessing film 11. In the organic projecting and recessing film 11, the following projecting and recessing pattern is formed; i.e., the dimensions of the unit area are prescribed so that one edge is integral multiple of a unit pixel and 1900 μm or more, and smaller than the dimensions of the entire screen; the deviation of the length of the edge or distance between the centers conforms to its Gaussian distribution, and the center or each of the apexes is disposed at a position where the intersection point of regular grids is shifted so that the deviation of the length of edge or distance between the centers conform to the Gaussian distribution. Formed on the organic projecting and recessing film 11 is a pixel electrode 12 of a metal material such as Al or Al alloy, which also functions as the reflector. In the opposed substrate 1b, formed on a transparent insulation substrate 14 are a color filter 15 for displaying RGB colors, a black matrix for shielding excessive light and an opposed electrode 16 formed from ITO (indium tin oxide). And formed on the opposing surfaces of the substrates are alignment layers 13 and 17. Being interposed by spacers, the substrates are bonded to each other to form a desired gap. And in the gap, the liquid crystal 18 is sandwiched to form a reflective-type LCD module.

The manufacturing method of the TFT substrate 1a constituting the reflective-type LCD module will be described with reference to FIGS. 7A, 7B, 7C and 7D.

First of all, as shown in FIG. 7A, on the transparent insulation substrate 5 such as glass, a metal such as Cr is piled up, and then using a well-known photolithography technique and etching technique, a gate line and gate electrode 6 is formed. Then, being interposed by the gate insulation film 7 of SiO2, SiNx, SiOx or the like, the semiconductor layer 8 of a-Si or the like is piled up. After subjecting to patterning into an island-like shape, a metal such as Cr is piled up and subjected to patterning to form the data line, the source electrode 9a and the drain electrode 9b. After that, SiNx or the like is piled up using plasma CVD or the like to form passivation film 10 for protecting the TFT.

Then, as shown in FIG. 7B, on the passivation film 10, photosensitive resin 11a, which becomes the organic projecting and recessing film 11 for forming the projecting and recessing of the reflector, is coated using spin coating method. Although the kind of the photosensitive resin 11a is not particularly limited, acrylic resin, epoxy resin, silicone resin and phenolic resin are available. As for the photosensitive acrylic resin, for example, PC403, 415G and 405G prepared by JSR are available.

Then, by exposing the photosensitive resin 11a using a photomask, and on the surface layer thereof, a prescribed projecting and recessing pattern is formed.

In conventional LCD modules, in order to prevent the interference caused from the regularity of the projecting and recessing, within the unit area, four areas each having different standard deviation of the distribution of distance between the center of the recessing portion or projecting portion are formed (Japanese Patent Application Laid-Open No. Hei 11-337935); areas where projecting and recessing are regularly disposed and areas irregularly disposed therewith are arranged alternately in a unit area (Japanese Patent Application Laid-Open No. 2001-201743); and the projecting and recessing are irregularly formed in a unit area of 100 to 2000 dots (Japanese Patent Application Laid-Open No. 2003-302633 and Japanese Patent Application Laid-Open No. 2003-302742).

However, as described in the embodiment of the present invention, to reliably prevent the interference caused from the regularity of the projecting and recessing, both of the dimension of the unit area and the irregularity of the projecting and recessing pattern within the unit area have to be prescribed. Therefore, conventional arrangements failed to prevent the stain due to the interference.

Therefore, in the embodiment of the present invention, the photosensitive resin 11a is exposed using the following photomask. That is, the dimension of one edge of the unit area is prescribed as 1900 μm or more; and in each unit area, the apex of the projecting and recessing pattern is disposed so that the standard deviation of the distribution of distance between the grids conforms to the Gaussian distribution of 3 or more and 14 or less, preferably 5 or more and 14 or less by irregularly shifting the intersection point of the basic grids, in which basic figures (any configuration of regular triangle, regular tetragon, rectangle etc) are regularly disposed.

The forming method of the projecting and recessing is not particularly limited. For example, a portion corresponding to the recessing portion of the projecting and recessing pattern is subjected to under exposure with a small exposure amount; a portion corresponding to the projecting portion is not subjected to the exposure; and a portion corresponding to a contact hole on the source electrode 9a is subjected to the exposure with a sufficient exposure amount. To carry out the above exposure, plural photomasks (a photomask for exposing a portion corresponding to the recessing portion and a photomask for exposing a portion corresponding to the contact hole etc) may be used. The following half tone (gray tone) mask may be used. That is, a portion corresponding to the projecting portion is formed with a reflection film; an area corresponding to a portion where the photosensitive resin 11a is completely removed like contact hole is formed with a transparent film; and a portion corresponding to the recessing portion is formed with a semi-transparent film. When the half tone mask is used, the projecting and recessing can be formed by one exposure.

After that, as shown in FIG. 7C, using an alkali developer, the projecting and recessing are formed on the surface of the photosensitive resin 11a utilizing the difference in solving speed into an alkali solution in each of the recessing portion; projecting portion and contact hole. And then, the photosensitive resin 11a is subjected to, for example, a curing at 220° C. for about one hour. Thus, the organic projecting and recessing film 11 having a desired configuration is formed.

Next, as shown in FIG. 7D, using sputtering, deposition or the like, inside of the contact holes formed in the upper portion of the organic projecting and recessing film 11 and on the source electrode 9a, a film of metal material such as Al, Al alloy or the like is formed to form the pixel electrode 12 connected to the source electrode 9a. The pixel electrode 12 is utilized as the reflector. After that, the alignment layer 13 of polyimide is formed on the pixel electrode 12; thus the TFT substrate 1a is manufactured. And between the opposed substrate 1b formed with the color filter 15, the black matrix and the opposed electrode 16, and applied with alignment layer 17 thereon, liquid crystal is sandwiched. A retardation film and a polarization plate are provided to the outside of the opposed substrate 1b; thus, the reflective-type LCD module is completed.

The above-description has been made for the reflective-type LCD module. As shown in FIG. 8, the present invention is applicable to the semi-transmission type LCD module, in which a reflection area and a transmission area are formed in one pixel, and the reflector is formed in the reflection area only. Hereinafter, the manufacturing method of a TFT substrate 1a constituting the semi-transmission type LCD module will be schematically described with reference to FIGS. 9A, 9B, 9C and 9D.

First of all, as shown in FIG. 9A, in the same manner as the reflective-type LCD module, on the transparent insulation substrate 5 such as glass, a metal such as Cr is piled up, and a gate line and gate electrode 6 is formed. Next, being interposed by the gate insulation film 7 of SiO2, SiNx, SiOx or the like, the semiconductor layer 8 of a-Si or the like is piled up. After subjecting to patterning into an island-like shape, a metal such as Cr is piled up to form the data line, the source electrode 9a and the drain electrode 9b. After that, SiNx film or the like is piled up using plasma CVD or the like to form passivation film 10 for protecting the TFT.

Then, in the case of the semi-transmission type LCD module, since the pixel electrode of a metal material cannot be formed in the transmission area, after forming an opening above the source electrode 9a, a transparent conductive film such as ITO is formed all over the surface by means of sputtering. And after being subjected to a patterning, the transparent electrode 19 is formed over each pixel. After that, as shown in FIG. 9B, photosensitive resin 11a, which will be the organic projecting and recessing film 11 for forming the projecting and recessing of the reflector, is applied over the transparent electrode 19 by means of spin coating.

Then, using a photomask, the portion corresponding to the recessing portion of the projecting and recessing pattern is subjected to an under exposure using a small exposure amount; the portion corresponding to the projecting portion is not exposed; and the portion corresponding to the transmission area is exposed using a satisfactory exposure amount. Thus, a prescribed projecting and recessing pattern is formed in the surface layer of the reflection area. In this embodiment also, the photosensitive resin 11a is exposed using the following photomask. That is, the dimension of an edge of the unit area is prescribed as integral multiple of the unit pixel and 1900 μm or more, and smaller than the entire screen, and in each unit area, the apex of the projecting and recessing pattern is disposed so that the standard deviation of the distribution of distance between the grids conforms to the Gaussian distribution of 3 or more and 14 or less, preferably 5 or more and 14 or less by irregularly shifting the intersection point of the basic grids, in which basic figures are regularly disposed.

After that, as shown in FIG. 9C, using alkali developer, the projecting and recessing are formed on the surface of the photosensitive resin 11a utilizing the difference in solving speed into an alkali solution of each of the recessing portion, projecting portion and transmission area; and then, for example, subjected to curing at 220° C. for about one hour. Thus, the organic projecting and recessing film 11 having a desired configuration is formed.

Next, as shown in FIG. 9D, using sputtering, deposition or the like, in the upper portion of the organic projecting and recessing film 11 and in a part of transparent electrode film 19, a film of metal material such as Al, Al alloy or the like is formed to form the pixel electrode 12 connected to the source electrode 9a. After that, the alignment layer 13 of polyimide is formed on the transparent electrode 19 and the reflector; thus the TFT substrate 1a is manufactured. And the liquid crystal is sandwiched between the TFT substrate 1a and the opposed substrate 1b formed with the color filter 15, the black matrix and the opposed electrode 16 and applied with alignment layer 17 thereon. A retardation film and a polarization plate are provided outside of the opposed substrate 1b; thus, the semi-transmission type LCD module is formed.

Next, in order to verify the effectiveness of the present invention, using the above-described methods, the following samples were prepared. That is, the distribution of the length of edge of the projecting and recessing pattern with respect to the distance between grids of the basic grids substantially conform to the Gaussian distribution, of which standard deviation (hereinafter, the value of standard deviation of the Gaussian distribution is called as “an irregularity”) is 1, 3, 5, respectively. On each of the samples, laser beam of 670.5 nm in wavelength and 2 mm in diameter was irradiated, and diffraction images thereof were measured. FIGS. 10A, B and C and FIGS. 11A, B and C show the results. FIGS. 10A, B and C are diffraction images respectively when laser beam was irradiated onto a reflective-type LCD module. FIGS. 11A, B and C are diffraction images respectively when laser beam was irradiated onto a semi-reflective type LCD module.

In the case of the reflective-type LCD module, when the irregularity is 1 as shown in FIG. 10C, diffraction images of four times or more were observed; when the irregularity is 3 as shown in FIG. 10B, diffraction images of three times were observed; and when the irregularity is 5 as shown in FIG. 10A, diffraction images of twice were observed. In the case of the semi-transmission type LCD module, when the irregularity is 1 as shown in FIG. 11C, diffraction images of twice or more were observed; and when the irregularity is 3 and 5 as shown in FIG. 11B and FIG. 11A, no diffraction images were observed.

From the above results, the following facts were verified. That is, when the irregularity of the projecting and recessing pattern within the unit area is set to 5 or more (i.e., the distribution of the position of apexes or distance between apexes of the recessing portion or projecting portion conforming to the Gaussian distribution of which standard deviation is 5 or more are irregularly disposed), number of diffractions can be reduced to twice or less; thus, the interference caused from the regularity of the projecting and recessing can be prevented. Also, it was verified that, when the irregularity is 3 to 5, the visibility was reduced due to the stain caused from the interference, but compared to the case where the irregularity is smaller than 3, the visibility was improved. The reason why the number of diffractions with respect to the irregularity is different between the reflective-type LCD module and the semi-transmission type LCD module is understandable as described below. That is, in the case of the semi-transmission type LCD module, since the transmission area with no projecting and recessing is formed between the projecting and recessing patterns of the neighboring pixels, the diffraction hardly occurs.

As described above, according to the LCD modules of the embodiment of the present invention, an LCD module with satisfactorily display quality can be achieved by arranging the reflector used in the reflective-type LCD module or semi-transmission type LCD module as described below. That is, the dimensions of the unit area is prescribed so that one edge is integral multiple of the unit pixel and 1900 μm or more, and smaller than the size of the entire screen, and by disposing the projecting and recessing pattern formed by repeating a basic figure such as polygon, circle or ellipse within each of the unit areas so that the length of the edge or the distribution of distance between the centers conforms to the Gaussian distribution with standard deviation 3 to 14 (preferably, 5 to 14), and by disposing the center or each of the apexes to a position where the intersection point of the regular grids is shifted so that the length of the edge or the distribution of distance between the centers conforms to the Gaussian distribution with standard deviation 3 to 14 (preferably, 5 to 14), the interference caused from both of the regularity of the projecting and recessing within the unit area and the regularity of the projecting and recessing among the unit areas can be prevented; thus, the stain is prevented.

By forming the reflector as described above, the necessity of application of diffusion paste in which TiO2 or the like is dispersed and anti-glare treatment (AG treatment) can be eliminated. Therefore, the number of processes and materials can be reduced. The degrading of the reflection performance and transmission performance caused by the diffusion paste are also prevented.

In the described embodiments, the projecting and recessing is formed only on the organic projecting and recessing film 11. However, the projecting and recessing may be formed using two more layers of organic film. Further, in the above-described embodiments, the projecting and recessing are formed on the surface layer of the organic projecting and recessing film 11. The organic film may be separated into an island-like shape to form the projecting and recessing. Furthermore, in the above-described embodiments, the reflector is formed at the TFT substrate 1a side. However, when the rear face side of the TFT substrate 1a is used as the display surface, the reflector may be formed at the opposed substrate 1b side. Still further, such arrangement, in which a reflector formed with the projecting and recessing pattern conforming to the above-described prescription is additionally provided to the outside of a pair of substrates, may be employed.

The LCD module of the present invention is applicable to any LCD modules of arbitrary drive system such as a TN type LCD module in which each substrate is provided with a transparent electrode, and using the vertical electric field between the substrates, the liquid crystal is driven, or an IPS type LCD module, in which comb-like electrodes are provided to one substrate, and the liquid crystal is driven by the electric field between the comb-like electrodes.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, it is noted that the inventor's intent is to refrain all equivalents of the claimed invention even if the claims are amended during prosecution.

What is claimed is:

1. A reflector for reflecting light incident on an LCD module to utilize the light as a light source for display, comprising:
a plurality of projecting and recessing patterns disposed on said reflector irregularly, each projecting and recessing pattern corresponding to prescribed polygon shape as a grid being repeated in the plane direction of said reflector so that the length of the edge or the distribution of distance between the centers of each projecting and recessing pattern conforms to the Gaussian distribution; and
a unit area constituted of the plurality of polygon shapes formed with the projecting and recessing pattern, of which dimensions are prescribed so that one edge of the unit area is integral multiple of a unit pixel and substantially 1900 μm or more, and smaller than or equal to the entire screen of the LCD module;
wherein the center or all of the edges of the polygon of the projecting and recessing pattern are formed in a recessing portions or projecting portions respectively.

2. A reflector for reflecting light incident on an LCD module to utilize the light as a light source for display, comprising:
A plurality of projecting and recessing patterns disposed on said reflector irregularly, each projecting and recessing pattern corresponding to prescribed polygon shape, of which center or each of the apexes is disposed at a position where intersection point of each grid being shifted, is repeated in the plane direction of said reflector so that the length of the edge or the distribution of distance between the centers of each projecting and recessing pattern conforms to the Gaussian distribution; and
a unit area constituted of the plurality of polygon shapes formed with the projecting and recessing pattern, of which dimensions are prescribed so that one edge of the unit area is integral multiple of a unit pixel and substantially 1900 μm or more, and smaller than or equal to the entire screen of the LCD module;
wherein the center or all of the edges of the polygon of the projecting and recessing pattern are formed in a recessing portions or projecting portions respectively.

3. The reflector according to claim 1, wherein the projecting and recessing pattern is a pattern, in which a circle or ellipse prescribed so that the distribution of distance between the centers conforms to the Gaussian distribution, is repeated in the plane direction, and the center or the entire periphery of the circle or ellipse is formed with any one of the recessing portion or projecting portion.

4. The reflector according to claim 2, wherein the projecting and recessing pattern is a pattern of a circle or ellipse, of which center is disposed at a position where the intersection point of regular grids is shifted so that the distribution of distance between the centers conforms to the Gaussian distribution, is repeated in the plane direction, and the center or the entire periphery of the circle or ellipse is formed with any one of the recessing portion or projecting portion.

5. The reflector according to claim 1, wherein the standard deviation of the Gaussian distribution is 3 or more and 14 or less.

6. The reflector according to claim 2, wherein the standard deviation of the Gaussian distribution is 3 or more and 14 or less.

7. The reflector according to claim 1, wherein the standard deviation of the Gaussian distribution is 5 or more and 14 or less.

8. The reflector according to claim 2, wherein the standard deviation of the Gaussian distribution is 5 or more and 14 or less.

9. An LCD module, utilizing a reflecting light of an incident light as a light source for display, comprising:
a plurality of projecting and recessing patterns disposed on a reflector for reflecting the incident light irregularly, each projecting and recessing pattern corresponding to prescribed polygon shape as a grid being repeated in the plane direction of said reflector so that the length of the edge or the distribution of distance between the centers of each projecting and recessing pattern conforms to the Gaussian distribution; and
a unit area of the reflector constituted of the plurality of polygon shapes formed with the projecting and recessing pattern, of which dimensions are prescribed so that one edge of the unit area is integral multiple of a unit pixel and substantially 1900 μm or more, and smaller than or equal to the entire screen of the LCD module;
wherein the center or all of the edges of the polygon of the projecting and recessing pattern are formed in a recessing portions or projecting portions respectively.

10. An LCD module, utilizing a reflecting light of an incident light as a light source for display, comprising:
a plurality of projecting and recessing patterns disposed on a reflector for reflecting the incident light irregularly, each projecting and recessing pattern corresponding to prescribed polygon shape, of which center or each of the apexes is disposed at a position where intersection point of each grid being shifted, is repeated in the plane direction of said reflector so that the length of the edge or the distribution of distance between the centers of each projecting and recessing pattern conforms to the Gaussian distribution; and
a unit area of the reflector constituted of the plurality of polygon shapes formed with the projecting and recessing pattern, of which dimensions are prescribed so that one edge of the unit area is integral multiple of a unit pixel and substantially 1900 μm or more, and smaller than or equal to the entire screen of the LCD module;
wherein the center or all of the edges of the polygon of the projecting and recessing pattern are formed in a recessing portions or projecting portions respectively.

11. The LCD module according to claim 9, wherein the projecting and recessing pattern formed on the reflector is a pattern in which a prescribed circle or ellipse prescribed is repeated in the plane direction so that the distribution of distance between the centers conforms to the Gaussian distribution, and the center or the entire periphery of the circle or ellipse is formed with any one of the recessing portion or projecting portion.

12. The LCD module according to claim 10, wherein the projecting and recessing pattern formed on the reflector is a pattern of a circle or ellipse, of which center is disposed at a position where the intersection point of regular grids is shifted, is repeated in the plane direction so that the distribution of distance between the centers conform to the Gaussian distribution, and the center or the entire periphery of the circle or ellipse is formed with any one of the recessing portion or projecting portion.

13. The LCD module according to claim 9, wherein the standard deviation of the Gaussian distribution is 3 or more and 14 or less.

14. The LCD module according to claim 10, wherein the standard deviation of the Gaussian distribution is 3 or more and 14 or less.

15. The LCD module according to claim 9, wherein the standard deviation of the Gaussian distribution is 5 or more and 14 or less.

16. The LCD module according to claim 10, wherein the standard deviation of the Gaussian distribution is 5 or more and 14 or less.
